(19) United States
(12) Patent Application Publication
(10) Pub. No.: US 2013/0133320 A1
(43) Pub. Date: May 30, 2013

(54) HYDRAULIC PRESSURE CONTROL APPARATUS FOR AUTOMATIC TRANSMISSION

(71) Applicants: Jin Young Hwang, Suwon-si (KR); Se Hwan Jo, Goyang-si (KR)

(72) Inventors: Jin Young Hwang, Suwon-si (KR); Se Hwan Jo, Goyang-si (KR)

(73) Assignee: Hyundai Motor Company, Seoul (KR)

(21) Appl. No.: 13/526,143

(22) Filed: Jun. 18, 2012

(30) Foreign Application Priority Data
Nov. 29, 2011 (KR) 10-2011-0126331

(51) Int. Cl. F16H 61/30; F16H 61/00

(52) U.S. Cl. 60/422

(57) ABSTRACT

A hydraulic pressure control apparatus may include an oil tank, a first hydraulic pump receiving oil from the oil tank generating a low pressure, a second hydraulic pump receiving the low pressure and generating a high pressure, a torque converter and a lubrication portion receiving the low pressure, a powertrain receiving the high pressure, a pump connecting line connecting the first hydraulic pump with the second hydraulic pump, a first bypass line adapted to supply hydraulic pressure from the oil tank to the second hydraulic pump by detouring around the first hydraulic pump, and a second bypass line bifurcated from the pump connecting line so as to supply hydraulic pressure to the powertrain by detouring around the second hydraulic pump, wherein the first bypass line and the second bypass line respectively include a check valve and are selectively opened/closed by operation of each check valve.

### CROSS-REFERENCE TO RELATED APPLICATION

The present application claims priority of Korean Patent Application Number 10-2011-0126331 filed Nov. 29, 2011, the entire contents of which application is incorporated herein for all purposes by this reference.

### BACKGROUND OF INVENTION

1. Field of Invention

The present invention relates to a hydraulic pressure control apparatus for an automatic transmission. More particularly, the present invention relates to a hydraulic pressure control apparatus for an automatic transmission that is provided with two oil pumps.

2. Description of Related Art

Generally, an automatic transmission includes a torque converter and a powertrain. In addition, the powertrain realizes multiple shifts by being connected with the torque converter. Further, a hydraulic pump (electric oil pump) is provided so as to supply operating pressure to the automatic transmission, and a TCU (transmission control unit) is provided so as to control operation of the automatic transmission.

Recently, a hydraulic pressure control apparatus for an automatic transmission having two hydraulic pumps has been applied so as to enhance fuel consumption. Pressure of oil supplied from an oil tank is sequentially increased via the two hydraulic pumps in a hydraulic pressure control apparatus for an automatic transmission having two hydraulic pumps. In addition, oil forms a low pressure portion via one hydraulic pump and further forms a high pressure portion via the other hydraulic pump. Oil of the low pressure portion is supplied to a torque converter and a lubrication portion and oil of the high pressure portion is supplied to a powertrain so as to operate brakes and clutches.

Meanwhile, in a hydraulic pressure control apparatus for an automatic transmission having the two hydraulic pumps, when hydraulic pressure of the high pressure portion is deteriorated, even momentarily, the function of the brakes and the clutches is reduced and durability thereof is deteriorated.

In addition, when performance of one of the two hydraulic pumps is deteriorated or the first hydraulic pump fails, necessary hydraulic pressure for pumping to the high pressure portion may not be supplied to the other of the two hydraulic pumps. Further, when performance of the other of the two hydraulic pumps is deteriorated or a failure of the first hydraulic pump occurs, sufficient hydraulic pressure may not be supplied to the high pressure portion.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a hydraulic pressure control apparatus for an automatic transmission having advantages of appropriately supplying hydraulic pressure to a high pressure portion when at least one of two hydraulic pumps is normally operated.

Various aspects of the present invention provide for hydraulic pressure control apparatus for an automatic transmission that may include an oil tank for storing oil, a first hydraulic pump connected with the oil tank to receive oil from the oil tank, and adapted to generate a low pressure, a second hydraulic pump connected with the first hydraulic pump to receive the low pressure, and adapted to generate a high pressure, a torque converter and a lubrication portion adapted to receive the low pressure from the first hydraulic pump, a powertrain adapted to receive the high pressure from the second hydraulic pump, a pump connecting line connecting the first hydraulic pump with the second hydraulic pump, a first bypass line adapted to supply hydraulic pressure from the oil tank to the second hydraulic pump by detouring around the first hydraulic pump, and a second bypass line bifurcated from the pump connecting line so as to supply hydraulic pressure to the powertrain by detouring around the second hydraulic pump, wherein the first bypass line and the second bypass line respectively include a check valve and are selectively opened/closed by operation of each check valve.

The first bypass line may be opened such that the second hydraulic pump receives oil from the oil tank when a performance of the first hydraulic pump is deteriorated or a failure of the first hydraulic pump occurs.

The second bypass line may be opened such that the first hydraulic pump supplies hydraulic pressure to the powertrain when a performance of the second hydraulic pump is deteriorated or a failure of the second hydraulic pump occurs.

Each of the check valves may be a one-way valve.

The apparatus may include a first regulating valve adapted to receive the low pressure from the first hydraulic pump and to regulate an operating pressure to supply to the torque converter and the lubrication portion, and a second regulating valve adapted to receive the high pressure from the second hydraulic pump and to regulate an operating pressure to supply to the powertrain.

The second bypass line may detour around the second regulating valve and may be directly connected with the powertrain.

The apparatus may include a variable control solenoid valve supplying control pressure to the first and second regulating valves.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary hydraulic pressure control apparatus for an automatic transmission according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

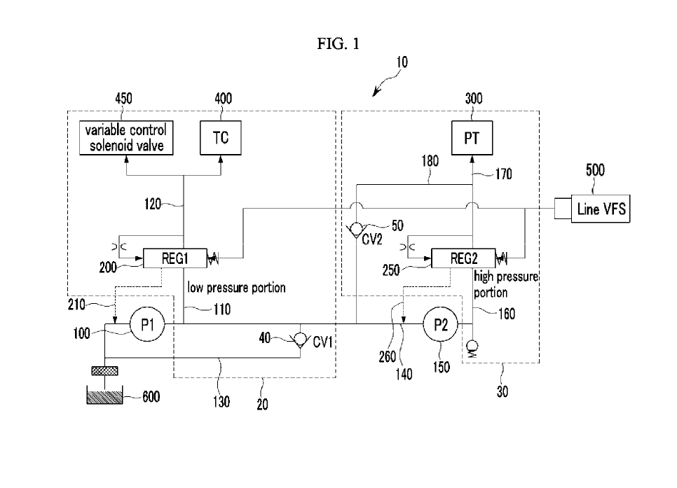

FIG. 1 is a schematic diagram of a hydraulic pressure control apparatus for an automatic transmission according to various embodiments of the present invention.

As shown in FIG. 1, a hydraulic pressure control apparatus 10 for an automatic transmission according to various embodiments of the present invention includes a powertrain 300, a torque converter 400, a lubrication portion 450, an oil tank 600, a first hydraulic pump 100, a second hydraulic pump 150, a first regulating valve 200, a second regulating valve 250 and a variable control solenoid valve 500.

The powertrain 300 is adapted to transfer output of an engine to a wheel, and is provided with clutches, brakes, a transmission, an impellent shaft, planetary gear sets, and a drive shaft. The powertrain 300 is provided to the general automatic transmission, and is well-known to a person of ordinary skill in the art. Therefore, a detailed description thereof will be omitted.

The torque converter 400 is adapted to transfer torque by using fluid and to amplify the torque. The torque converter 400 is provided in a general automatic transmission and is well-known to a person of ordinary skill in the art. Therefore, a detailed description thereof will be omitted.

The lubrication portion 450 supplies oil so as to lubricate an engine and the powertrain 300.

The oil tank 600 stores oil to generate hydraulic pressure so as to operate the hydraulic pressure control apparatus 10.

The first hydraulic pump 100 pumps oil supplied from the oil tank 600 and forms a low pressure portion 20 by the operation. In addition, the second hydraulic pump 150 pumps oil supplied from the first hydraulic pump 100 and forms a high pressure portion 30 by the operation. Further, the oil of the low pressure portion 20 is supplied to the torque converter 400 and the lubrication portion 450, and the oil of the high pressure portion 30 is supplied to the powertrain 300. The oil of high pressure portion 30 supplied to the powertrain 300 forms hydraulic pressure to operate a clutch and a brake provided at the powertrain 300. Meanwhile, the first hydraulic pump 100 and the second hydraulic pump 150 may be electric hydraulic pumps operated by a motor.

The first regulating valve 200 is disposed between the first hydraulic pump 100 and both of the torque converter 400 and the lubrication portion 450, and maintains hydraulic pressure supplied to the torque converter 400. In other words, the oil pumped from the first hydraulic pump 100 is supplied to the torque converter 400 via the first regulating valve 200.

The second regulating valve 250 is disposed between the second hydraulic pump 150 and the powertrain 300, and maintains hydraulic pressure supplied to the powertrain 300. In other words, the oil pumped from the second hydraulic pump 150 is supplied to the powertrain 300 via the second regulating valve 250.

The variable control solenoid valve 500 is connected to the first regulating valve 200 and the second regulating valve 250 so as to change the target hydraulic pressure of the first regulating valve 200 and the second regulating valve 250. In other words, the target hydraulic pressure can be changed according to control pressure of the variable control solenoid valve 500.

Referring to FIG. 1, a structure of oil lines provided at a hydraulic pressure control apparatus 10 for an automatic transmission according to various embodiments of the present invention will be described in detail.

The hydraulic pressure control apparatus 10 for an automatic transmission further includes a pump connecting line 140, first and second low pressure supply lines 110 and 120, first and second high pressure supply lines 160 and 170, first and second recirculation lines 210 and 260, and first and second bypass lines 130 and 180.

The pump connecting line 140 connects the first hydraulic pump 100 with the second hydraulic pump 150. In other words, the oil pumped by the first hydraulic pump 100 is supplied to the second hydraulic pump 150 via the pump connecting line 140, and the oil is adapted to be pumped again by the second hydraulic pump 150.

The first low pressure supply line 110 is bifurcated from the pump connecting line 140 and is connected to the first regulating valve 200. In other words, a part of the oil pumped by the first hydraulic pump 100 is supplied to the second hydraulic pump 150, and the other part of the oil is supplied to the first regulating valve 200.

The second low pressure supply line 120 connects the first regulating valve 200 with the torque converter 400 and the lubrication portion 450. In other words, the oil passing through the first regulating valve 200 is supplied to the torque converter 400 and the lubrication portion 450 through the second low pressure supply line 120. In addition, the second low pressure supply line 120 is divided into two lines, and one of the two lines is connected with the torque converter 400 and the other is connected with the lubrication portion 450.

The first recirculation line 210 recirculates remaining oil in the first regulating valve 200 to the first hydraulic pump 100. In other words, a predetermined hydraulic pressure is supplied from the first regulating valve 200 to the torque converter 400 and the lubrication portion 450, and oil which is supplied excessively so as to generate hydraulic pressure higher than the predetermined hydraulic pressure is supplied back to the first hydraulic pump 100.

The first high pressure supply line 160 connects the second hydraulic pump 150 with the second regulating valve 250. In other words, the first high pressure supply line 160 supplies oil pumped from the second hydraulic pump 150 to the second regulating valve 250.

The second high pressure supply line 170 connects the second regulating valve 250 with the powertrain 300. In other words, the second high pressure supply line 170 supplies the oil supplied via the second regulating valve 250 to powertrain 300.

The second recirculation line 260 recirculates remaining oil in the second regulating valve 250 to the second hydraulic pump 150. In other words, a predetermined hydraulic pressure is supplied from the second regulating valve 250 to the powertrain 300, and oil which is supplied excessively so as to generate hydraulic pressure higher than the predetermined hydraulic pressure is supplied back to the second hydraulic pump 150.

The first bypass line 130 is connected on the pump connecting line 140 from the oil tank 600. In other words, the first bypass line 130 is bifurcated from a line connecting the oil tank 600 with the first hydraulic pump 100, bypasses the first hydraulic pump 100, and is connected with the pump connecting line 140. Thus, when performance of the first hydraulic pump 100 is deteriorated or the first hydraulic pump 100 fails, the second hydraulic pump 150 directly receives oil from the oil tank 600.

A first check valve 40 is mounted on the first bypass line 130 and selectively opens/closes the first bypass line 130. That is, the first check valve 40 is opened when performance of the first hydraulic pump 100 is deteriorated or the first hydraulic pump 100 fails.

As described above, the second hydraulic pump 150 can directly receive oil from the oil tank 600 when the first check valve 40 is opened. In addition, the first check valve 40 is closed when the first hydraulic pump 100 is normally operated. Further, the first check valve 40 may be a one-way valve that only passes oil from the oil tank 600 to the second hydraulic pump 150.

The second bypass line 180 is bifurcated from the pump connecting line 140 and is connected to the second high pressure supply line 170. In other words, the second bypass line 180 detours around the first hydraulic pump 100 and the second regulating valve 250. Thus, when performance of the second hydraulic pump 150 is deteriorated or the second hydraulic pump 150 fails, the oil pumped from the first hydraulic pump 100 is directly supplied to the powertrain 300.

A second check valve 50 is mounted on the second bypass line 180 and selectively opens/closes the second bypass line 180. In other words, the second check valve 50 is opened when performance of the second hydraulic pump 100 is deteriorated or the second hydraulic pump 100 fails.

As described above, the first hydraulic pump 100 can directly supply oil to the powertrain 300 when the second check valve 50 is opened. In addition, the second check valve 50 is closed when the second hydraulic pump 150 is normally operated. Further, the second check valve 50 may be a one-way valve that only passes oil to the powertrain 300.

A control unit may be provided in the hydraulic pressure control apparatus 10 for an automatic transmission according to various embodiments of the present invention so as to control selective opening/closing of the first and second check valves 40 and 50. The control unit is well-known to a person of ordinary skill in the art, and thus a detailed description thereof will be omitted.

Since oil bypasses the first hydraulic pump 100 and is supplied from the oil tank 600 to the second hydraulic pump 150 if performance of the first hydraulic pump 100 is deteriorated or the first hydraulic pump 100 fails, oil required for the second hydraulic pump 150 to pump may be supplied according to various embodiments of the present invention. Since oil bypasses the second hydraulic pump 150 and is supplied from the first hydraulic pump 100 to the high pressure portion 20 when a performance of the second hydraulic pump 150 is deteriorated or the second hydraulic pump 150 fails, hydraulic pressure may be supplied to the powertrain 300

Thus, hydraulic pressure may be smoothly supplied to the high pressure portion 20 when at least one of the two hydraulic pumps 100 and 150 is normally operated. Further, even though performance of one of the two hydraulic pumps 100 and 150 is deteriorated or a failure of one of the two hydraulic pumps 100 and 150 occurs, performance of the hydraulic pressure control apparatus 10 may be maintained. In other words, as the performance of the hydraulic pressure control apparatus 10 is enhanced, a driver can be satisfied and reliability of the hydraulic pressure control apparatus 10 can be enhanced.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hydraulic pressure control apparatus for an automatic transmission, comprising:
an oil tank for storing oil;
a first hydraulic pump connected with the oil tank to receive oil from the oil tank, and adapted to generate a low pressure;
a second hydraulic pump connected with the first hydraulic pump to receive the low pressure, and adapted to generate a high pressure;
a torque converter and a lubrication portion adapted to receive the low pressure from the first hydraulic pump;
a powertrain adapted to receive the high pressure from the second hydraulic pump;
a pump connecting line connecting the first hydraulic pump with the second hydraulic pump;
a first bypass line adapted to supply hydraulic pressure from the oil tank to the second hydraulic pump by bypassing the first hydraulic pump; and
a second bypass line bifurcated from the pump connecting line so as to supply hydraulic pressure to the powertrain by bypassing the second hydraulic pump,
wherein each of the first bypass line and the second bypass line include a check valve and are selectively opened and closed by operation of each check valve.

2. The apparatus of claim 1, wherein the first bypass line is opened such that the second hydraulic pump receives oil from the oil tank when a performance of the first hydraulic pump is deteriorated or a failure of the first hydraulic pump occurs.

3. The apparatus of claim 1, wherein the second bypass line is opened such that the first hydraulic pump supplies hydraulic pressure to the powertrain when performance of the second hydraulic pump is deteriorated or a failure of the second hydraulic pump occurs.

4. The apparatus of claim 1, wherein each of the check valves is a one-way valve.

5. The apparatus of claim 1, further comprising:
a first regulating valve adapted to receive the low pressure from the first hydraulic pump and to regulate an operating pressure to supply to the torque converter and the lubrication portion; and
a second regulating valve adapted to receive the high pressure from the second hydraulic pump and to regulate an operating pressure to supply to the powertrain.

6. The apparatus of claim 5, wherein the second bypass line detours around the second regulating valve and is directly connected with the powertrain.

7. The apparatus of claim 5, further comprising a variable control solenoid valve supplying control pressure to the first and second regulating valves.
